(19) United States
(12) Patent Application Publication
(10) Pub. No.: US 2015/0217755 A1
(43) Pub. Date: Aug. 6, 2015

(54) VEHICLE ENERGY MANAGEMENT SYSTEM AND METHOD

(71) Applicant: FORD GLOBAL TECHNOLOGIES, LLC, Dearborn, MI (US)

(72) Inventors: Paul Stephen BRYAN, Belleville, MI (US); Thomas CHROSTOWSKI, Chesterfield, MI (US); Kent HANCOCK, Ann Arbor, MI (US)

(73) Assignee: FORD GLOBAL TECHNOLOGIES, LLC, Dearborn, MI (US)

(21) Appl. No.: 14/172,929

(22) Filed: Feb. 5, 2014

(51) Int. Cl. B60W 20/00

(52) U.S. Cl. CPC B60W 20/106

(57) ABSTRACT

A method according to an exemplary aspect of the present disclosure includes, among other things, controlling a vehicle in an Electric Vehicle (EV) mode that utilizes electric-only power to propel the vehicle. The controlling step may be based on a selection of a travel range reservation.

### TECHNICAL FIELD

This disclosure relates to an electrified vehicle, and more particularly, but not exclusively, to a vehicle energy management system and method for controlling a vehicle.

### BACKGROUND

Electrified vehicles such as hybrid electric vehicles (HEV's), plug-in hybrid electric vehicles (PHEV's), battery electric vehicles (BEV's), or fuel cell vehicles differ from conventional motor vehicles in that they are powered by one or more electric machines (i.e., electric motors and/or generators) instead of or in addition to an internal combustion engine. In other words, electrified vehicles have more than one power source. High voltage current for powering the electric machines is typically supplied by a high voltage traction battery system having one or more battery cells that store energy.

Some electrified vehicles provide a driver with the ability to manually manage the energy usage of his/her vehicle. For example, the electrified vehicle may be operated in Electric Vehicle (EV) mode where the electric machine is used without help from the engine to power the vehicle, or may be operated in Hybrid (HEV) mode in which the engine is used in combination with the electric machine to power the vehicle. When managed incorrectly, the entire battery capacity of the electrified vehicle may not be fully utilized, thereby reducing fuel economy. Accordingly, further developments in the field of vehicle energy management are desirable.

### SUMMARY

A method according to an exemplary aspect of the present disclosure includes, among other things, controlling a vehicle in an Electric Vehicle (EV) mode that utilizes electric-only power to propel the vehicle. The controlling step may be based on a selection of a travel range reservation.

In a further non-limiting embodiment of the foregoing method, the travel range reservation is a distance in units of miles or kilometers.

In a further non-limiting embodiment of either of the foregoing methods, the method includes manually selecting the EV mode once a desired portion of a commute has been reached by the vehicle and powering the vehicle in the EV mode in response to the manually selecting step.

In a further non-limiting embodiment of any of the foregoing methods, the travel range reservation is part of an EV later mode strategy for controlling the vehicle.

In a further non-limiting embodiment of any of the foregoing methods, the method includes calculating a corresponding battery state of charge that is necessary to meet the travel range reservation demand.

In a further non-limiting embodiment of any of the foregoing methods, the method includes automatically powering the vehicle in EV mode based on navigation information.

In a further non-limiting embodiment of any of the foregoing methods, the method includes operating the vehicle in a charge depleting mode until a charge sustaining level is reached and operating the vehicle in a charge sustaining mode after the charge sustaining level has been reached.

In a further non-limiting embodiment of any of the foregoing methods, the method includes operating the vehicle in a second charge depleting mode once a desired portion of a commute is reached that corresponds to the travel range reservation.

In a further non-limiting embodiment of any of the foregoing methods, the method includes communicating control signals to at least an electric machine and an engine to schedule operating modes of the vehicle.

In a further non-limiting embodiment of any of the foregoing methods, the method includes selecting the travel range reservation on a driver interface of the vehicle.

A vehicle control method according to another exemplary aspect of the present disclosure includes, among other things, selecting a distance of electric-only travel to be reserved for powering a vehicle during a later portion of a commute and controlling the vehicle along the later portion of the commute based on the distance of electric-only travel that is reserved during the step of selecting.

In a further non-limiting embodiment of the foregoing method, the method includes calculating a corresponding battery state of charge that is necessary to power the vehicle over the distance of electric-only travel.

In a further non-limiting embodiment of either of the foregoing methods, the step of controlling is performed in response to manually selecting an EV mode.

In a further non-limiting embodiment of any of the foregoing methods, the step of controlling is automatically performed in response to navigation information.

In a further non-limiting embodiment of any of the foregoing methods, the method includes controlling the vehicle along another portion of the commute in a HEV mode.

A vehicle energy management system according to another exemplary aspect of the present disclosure includes, among other things, a driver interface configured to select a travel range reservation and a control unit in communication with the driver interface and configured to control a vehicle using electric-only power based on the reserved travel range.

In a further non-limiting embodiment of the foregoing system, the vehicle is a plug-in hybrid electric vehicle (PHEV).

In a further non-limiting embodiment of either of the foregoing systems, the driver interface includes a travel range reservation selector.

In a further non-limiting embodiment of any of the foregoing systems, the driver interface includes a mode selector having an EV mode button, an Automatic mode button, and a HEV mode button.

In a further non-limiting embodiment of any of the foregoing systems, a navigation system is in communication with the control unit.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates, in graphical form, exemplary operating modes of an electrified vehicle.

FIG. 3 illustrates a vehicle energy management system that can be used to control operation of an electrified vehicle.

FIG. 4 illustrates a driver interface of a vehicle energy management system.

FIG. 5 illustrates a travel range reservation selector according to a first embodiment of the present disclosure.

FIG. 6 illustrates a travel range reservation selector according to a second embodiment of this disclosure.

FIG. 7 schematically illustrates a vehicle energy management strategy for controlling a vehicle in response to a driver selected travel range reservation.

FIG. 8 schematically illustrates an implementation of the vehicle energy management strategy of FIG. 7.

FIG. 9 illustrates another battery energy management system that can be used to control operation of an electrified vehicle.

### DETAILED DESCRIPTION

This disclosure relates to an energy management system and method for an electrified vehicle. A driver may select a travel range reservation for operating the vehicle in EV mode that utilizes electric-only power to propel the vehicle. The travel range reservation represents a distance of electric-only travel the driver wishes to reserve for powering the vehicle during a portion of a commute. This selection may be made on a driver interface and can be expressed in units of miles, kilometers, or other units. These and other features are discussed in greater detail herein.

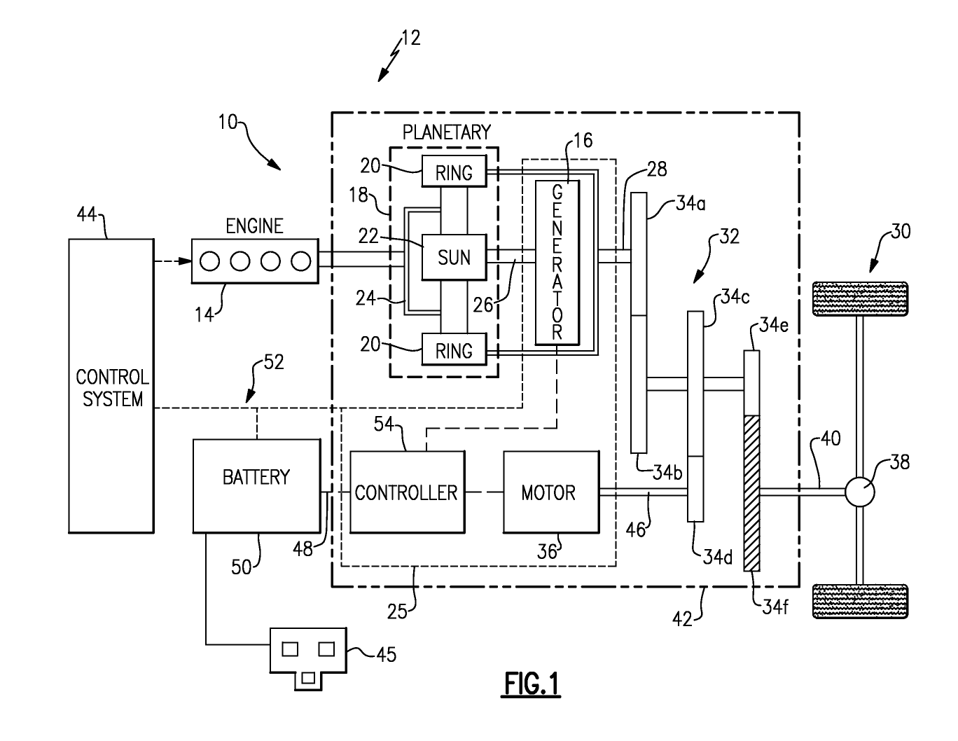

FIG. 1 schematically illustrates a powertrain 10 for an electrified vehicle 12 that is capable of implementing the energy management system and method of this disclosure. It should be understood that the concepts described herein are not limited to HEV's and could extend to other electrified vehicles, including but not limited to, PHEV's and fuel cell vehicles.

In one embodiment, the powertrain 10 is a power split system that employs a first drive system that includes a combination of an engine 14 and a generator 16 (i.e., a first electric machine) and a second drive system that includes at least a motor 36 (i.e., a second electric machine), the generator 16 and a battery 50. For example, the motor 36, the generator 16 and the battery 50 may make up an electric drive system 25 of the powertrain 10. The first and second drive systems generate torque to drive one or more sets of vehicle drive wheels 30 of the electrified vehicle 12.

The engine 14, such as an internal combustion engine, and the generator 16 may be connected through a power transfer unit 18. In one non-limiting embodiment, the power transfer unit 18 is a planetary gear set. Of course, other types of power transfer units, including other gear sets and transmissions, may be used to connect the engine 14 to the generator 16. The power transfer unit 18 may include a ring gear 20, a sun gear 22 and a carrier assembly 24. The generator 16 is driven by the power transfer unit 18 when acting as a generator to convert kinetic energy to electrical energy. The generator 16 can alternatively function as a motor to convert electrical energy into kinetic energy, thereby outputting torque to a shaft 26 connected to the carrier assembly 24 of the power transfer unit 18. Because the generator 16 is operatively connected to the engine 14, the speed of the engine 14 can be controlled by the generator 16.

The ring gear 20 of the power transfer unit 18 may be connected to a shaft 28 that is connected to vehicle drive wheels 30 through a second power transfer unit 32. The second power transfer unit 32 may include a gear set having a plurality of gears 34A, 34B, 34C, 34D, 34E, and 34F. Other power transfer units may also be suitable. The gears 34A-34F transfer torque from the engine 14 to a differential 38 to provide traction to the vehicle drive wheels 30. The differential 38 may include a plurality of gears that enable the transfer of torque to the vehicle drive wheels 30. The second power transfer unit 32 is mechanically coupled to an axle 40 through the differential 38 to distribute torque to the vehicle drive wheels 30.

The motor 36 can also be employed to drive the vehicle drive wheels 30 by outputting torque to a shaft 46 that is also connected to the second power transfer unit 32. In one embodiment, the motor 36 and the generator 16 are part of a regenerative braking system in which both the motor 36 and the generator 16 can be employed as motors to output torque. For example, the motor 36 and the generator 16 can each output electrical power to a high voltage bus 48 and the battery 50.

The battery 50 may be a high voltage battery that is capable of outputting electrical power to operate the motor 36 and the generator 16. Other types of energy storage devices and/or output devices can also be incorporated for use with the electrified vehicle 12. In a non-limiting PHEV embodiment of the electrified vehicle 12, the battery 50 may be recharged or partially recharged using a charging adapter 45 that is connected to a charging station powered by an external power source, such as an electrical grid, a solar panel, or the like.

The motor 36, the generator 16, the power transfer unit 18, and the power transfer unit 32 may generally be referred to as a transaxle 42, or transmission, of the electrified vehicle 12. Thus, when a driver selects a particular shift position, the transaxle 42 is appropriately controlled to provide the corresponding gear for advancing the electrified vehicle 12 by providing traction to the vehicle drive wheels 30.

The powertrain 10 may additionally include a control system 44 for monitoring and/or controlling various aspects of the electrified vehicle 12. For example, the control system 44 may communicate with the electric drive system 25, the power transfer units 18, 32 or other components to monitor and/or control the electrified vehicle 12. The control system 44 includes electronics and/or software to perform the necessary control functions for operating the electrified vehicle 12. In one embodiment, the control system 44 is a combination vehicle system controller and powertrain control module (VSC/PCM). Although it is shown as a single hardware device, the control system 44 may include multiple controllers in the form of multiple hardware devices, or multiple software controllers within one or more hardware devices.

A controller area network (CAN) 52 allows the control system 44 to communicate with the transaxle 42. For example, the control system 44 may receive signals from the transaxle 42 to indicate whether a transition between shift positions is occurring. The control system 44 could also communicate with a battery control module of the battery 50, or other control devices.

Additionally, the electric drive system 25 may include one or more controllers 54, such as an inverter system controller (ISC). The controller 54 is configured to control specific components within the transaxle 42, such as the generator 16 and/or the motor 36, such as for supporting bidirectional power flow. In one embodiment, the controller 54 is an inverter system controller combined with a variable voltage converter (ISC/VVC).

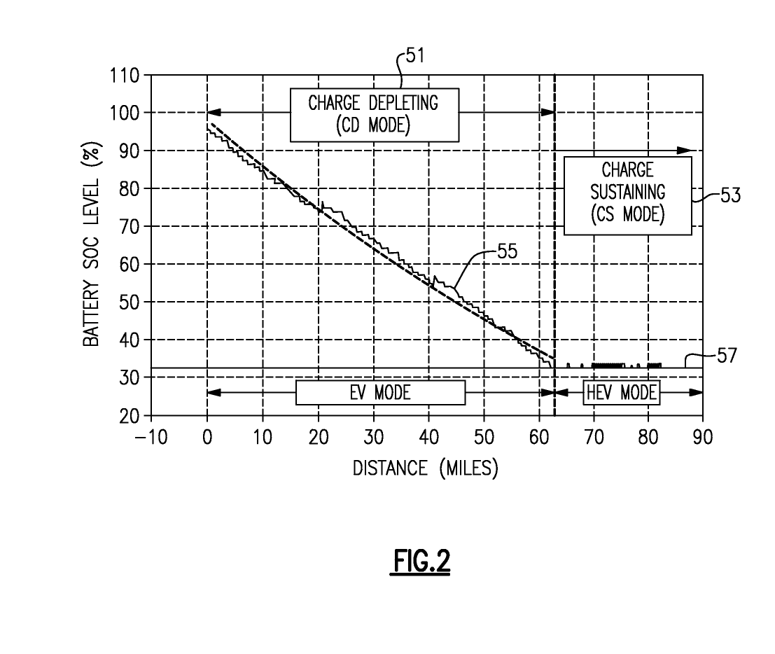

Exemplary operating modes of an electrified vehicle, such as the electrified vehicle 12 of FIG. 1, are illustrated with reference to FIG. 2. The depicted modes may be particularly suited for a PHEV; however, it is contemplated that the various embodiments of this disclosure are applicable for any type of electrified vehicle.

In one non-limiting embodiment, the electrified vehicle 12 has two basic operating modes. In a Charge Depleting (CD) mode 51, the battery 50 (see FIG. 1) may be primarily used to propel the electrified vehicle 12. The engine 14 (see FIG. 1) assists the vehicle drive power supply only in certain driving conditions or at excessive drive power requests during the CD mode 51. One characteristic of the CD mode 51 is that the motor 36 (see FIG. 1) consumes more energy from the battery 50 than can be regenerated. In a Charge Sustaining (CS) mode 53 (or HEV mode), the electrified vehicle 12 reduces the motor 36 propulsion usage to be able to maintain the battery's State of Charge (SOC) 55 (in percentage) at a constant or approximately constant level by increasing the engine 14 propulsion usage such that the battery SOC 55 level is generally maintained.

The electrified vehicle 12 may operate in an Electric Vehicle (EV) mode where the motor 36 is used (generally without help from the engine 14) for vehicle propulsion, depleting the battery SOC 55 up to its maximal allowable discharging rate under certain driving patterns/cycles. The EV mode is an example of a CD mode 51 of operation for the electrified vehicle 12. During EV mode, the battery 50 charge may increase in some circumstances, for example due to a period of regenerative braking. The engine 14 is generally not permitted to operate under a default EV mode, but may need to be operated based on a vehicle system state or as permitted by the operator through HEV mode selection as described further below.

Once the battery SOC 55 decreases to a predefined charge sustaining or charge hold level 57, the electrified vehicle 12 switches to CS mode 53, where the battery SOC 55 is kept within a vicinity of the charge sustaining level 57, and the electrified vehicle 12 is primarily powered by the engine 14. The electrified vehicle 12 may also operate in the CD mode 51 and CS mode 53 in any order, or with CD and CS modes occurring multiple times during a key cycle. Also, the CD mode 51 may have various battery discharging rates, or slopes. For example, the vehicle may be operated in CS mode 53 at a battery SOC 55 above the charge sustaining level 57, either based on a user selection, vehicle management, or the like, and then be operated in a CD mode 51 to use additional battery power.

As further described below, a driver may have the ability to select a preferred operation mode actively between electric and hybrid operation (EV/HEV) to override the automatic mode where the vehicle controller selects an operational mode for the vehicle. This permits a user to control the vehicle emissions, noise, and the like along the trip, and control the source of the power used by the vehicle, i.e. gasoline vs. electricity. For example, the driver may start by requesting an HEV driving mode in the initial section of the trip. This saves the battery SOC 55 such that the user can later switch to an EV driving mode at another location where EV operation of the vehicle is desirable.

FIG. 3 illustrates a vehicle energy management system 58 that can be used to control a vehicle 100. The vehicle 100 may be an electrified vehicle similar to that shown in FIG. 1. In one embodiment, the vehicle energy management system 58 is particularly suited for controlling operation of PHEV's, although any electrified vehicle may be controlled using the vehicle energy management system 58.

In addition to the operating modes described above and depicted in FIG. 2, the vehicle energy management system 58 permits operation of the vehicle 100 in an EV Later mode. In one non-limiting embodiment of an EV Later mode, a vehicle driver/operator can reserve a distance of travel for powering the vehicle 100 in EV mode at a later point in time. The reserved distance may be a desired travel range, expressed in units of miles or kilometers, which the driver wishes to reserve for powering the vehicle 100 in EV mode during a certain portion of a commute.

In one embodiment, the vehicle energy management system 58 includes a driver interface 60 and a control unit 62 in electrical communication with the driver interface 60. The driver interface 60 may include a user input 65 and a display 67, shown schematically in this embodiment. The user input 65 may include a touch screen and/or a series of tactile buttons 69. The display 67 may be a screen and/or a series of gauges for displaying information to the driver.

Using the driver interface 60, the driver of the vehicle 100 may select a travel range reservation for powering the vehicle in EV mode at a later point in time. The driver interface 60 is generally located inside the electrified vehicle 100, such as within the in-dash entertainment center of the passenger cabin. The information input into the driver interface 60 by the driver is communicated to the control unit 62 over an electrical connection 64.

The control unit 62 may be part of the control system 44 (see FIG. 1), may be part of a powertrain or transmission control system, or could be a stand-alone unit in communication with one or more other controllers. The control unit 62 may communicate with other controllers, modules and/or components over the CAN 52, in one embodiment.

The vehicle energy management system 58 may employ one or more algorithms programmed into the control unit 62 in order to schedule operation of the vehicle 100 in CD mode, CS mode or EV Later mode. For example, the control unit 62 may be programmed to operate the vehicle in EV Later mode based on a selected distance of electric-only travel that is reserved by the driver. The control unit 62 is also programmed to convert the travel range reservation into a battery SOC that is necessary to operate the vehicle 100 in EV mode over the reserved distance. The control unit 62 may communicate control signals 51 to an electric machine 66 and control signals S2 to an engine 68 for scheduling operation and controlling the vehicle 100 during the various operating modes. Although only a single electric machine 66 is shown, the vehicle 100 could include multiple electric machines within the scope of this disclosure.

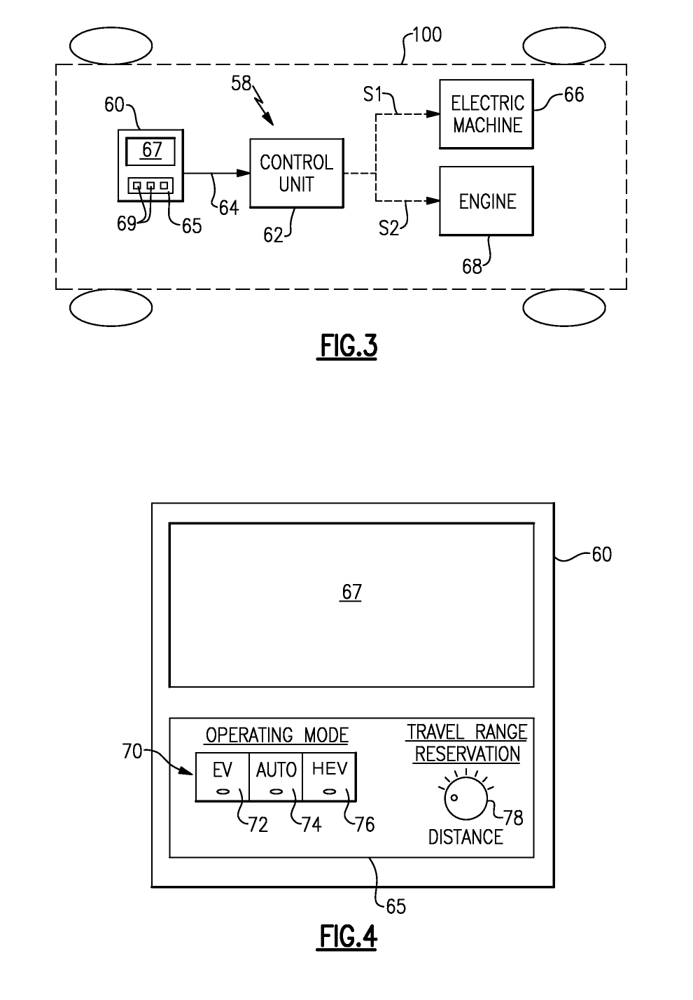

FIG. 4 illustrates one exemplary driver interface 60 of a vehicle energy management system 58. The driver interface 60 may include a user input 65 and a display 67. The user input 65 may include various actuators, selectors, switches or the like for inputting driver preferences for managing the energy usage of an electrified vehicle.

In one embodiment, the user input 65 of the driver interface 60 includes a mode selector 70 that allows a driver to select an operating mode preference for operating the vehicle. The mode selector 70 may include an EV mode button 72 for selecting EV mode, an Automatic mode button 74 for selecting automatic mode, and a HEV mode button 76 for selecting HEV mode. Of course, these are intended as non-limiting embodiments.

The user input 65 of the driver interface 60 may additionally include a travel range reservation selector 78. The travel range reservation selector 78 allows the vehicle operator to select a reserved travel range for powering the vehicle in EV mode at a later point in time. Put another way, the travel range reservation selector 78 enables the driver to schedule EV later mode by specifically entering a distance of electric-only drive travel, such as in miles or kilometers, which the driver wishes to reserve for powering the vehicle during a later portion of a commute.

FIG. 5 illustrates a first embodiment of a travel range reservation selector 78. In this non-limiting embodiment, the travel range reservation selector 78 includes a knob 80 that may be turned or otherwise actuated by a user in order to input a desired travel range to be reserved for powering the vehicle in EV mode at a later point in time. In one embodiment, the knob 80 is rotatable relative to indicia 82 that are marked with a desired travel range reservation. In this embodiment, the knob 80 is aligned with the indicator associated with 10 miles, signifying that the driver has chosen to reserve a travel range totaling 10 miles for later EV mode operation. This disclosure is not limited to this example, and it should be understood that other travel ranges are also contemplated within this disclosure.

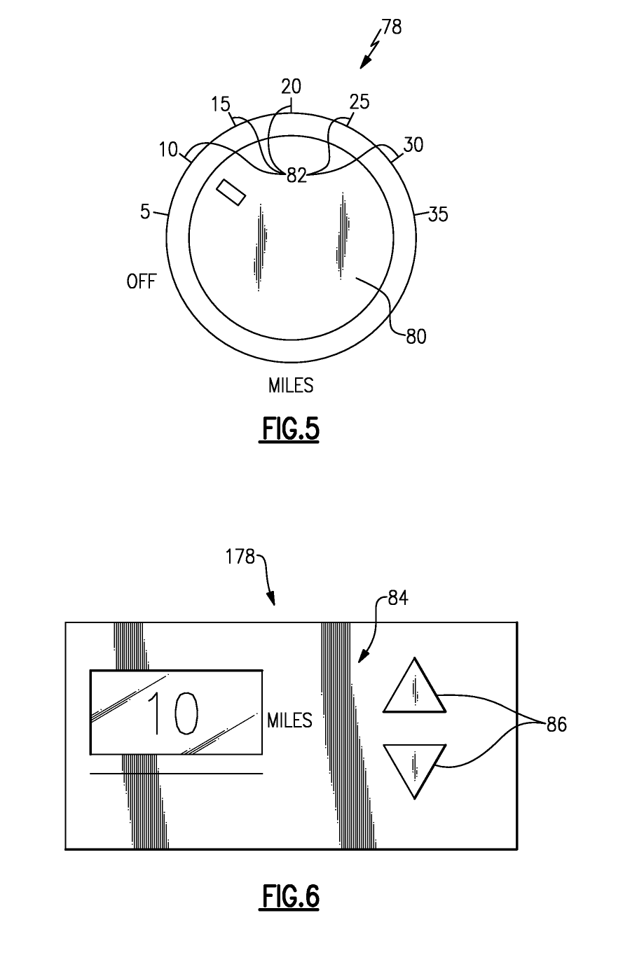

FIG. 6 illustrates another non-limiting embodiment of a travel range reservation selector 178 that can be implemented into the driver interface 60 of the vehicle energy management system 58. In this embodiment, the travel range reservation selector 178 includes a touch screen 84 having a plurality of tactile fields 86 that can be pressed by a user. In this embodiment, the tactile fields are represented by up and down arrows. For example, the tactile fields 86 can be tapped by the user to increase or decrease the reserved travel range distance.

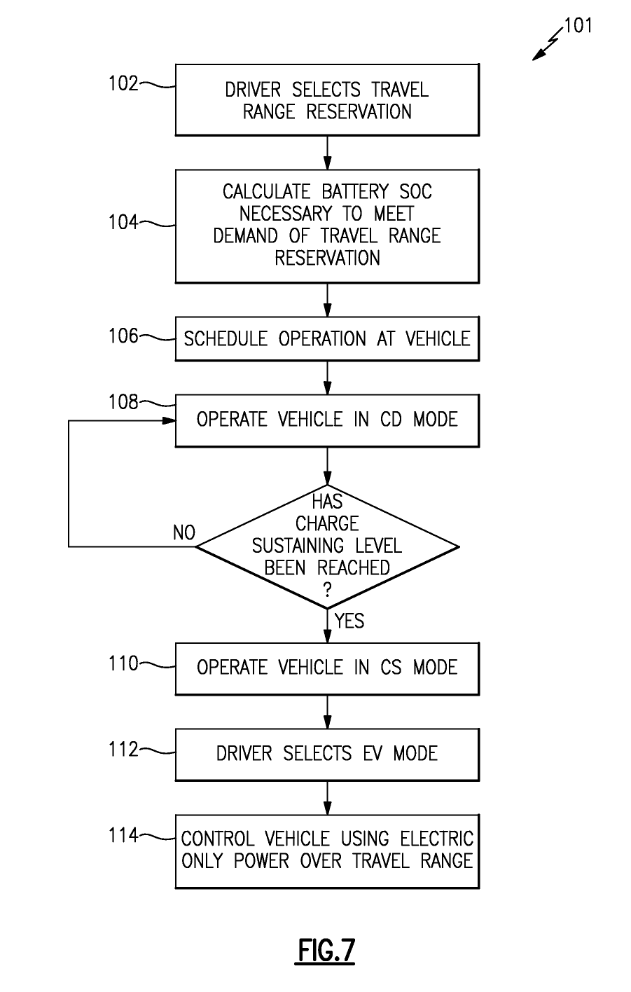

FIG. 7, with continued reference to FIGS. 1-6, schematically illustrates an energy management control strategy 101 for controlling a vehicle 100 using the vehicle energy management system 58. The energy management control strategy 101 begins at step 102 when a vehicle driver or user selects a travel range reservation for powering the vehicle 100 in EV mode using electric-only power during a later portion of a commute. The travel range reservation selection may be made using the driver interface 60, such as by using the travel range reservation selector 78, 178 (see FIGS. 5 and 6).

At step 104, based on the driver selected travel range reservation, the control unit 62 of the vehicle energy management system 58 calculates a corresponding battery SOC that is necessary to power the vehicle 100 in EV mode using electric-only power over the selected travel range reservation. The control unit 62 is programmed to include the necessary logic for making this calculation.

The control unit 62 then schedules operation of the vehicle 100 at step 106. In one embodiment, the control unit 62 communicates control signals S1, S2 to the electric machine 66 and engine 68 during the scheduling step. The schedule will include an EV later strategy that reserves the battery SOC calculated at step 104 for later use. In one embodiment, the control signals S1 include information regarding a charge sustaining level of the battery 50. The control unit 62 will not allow the battery 50 to drop below the charge sustaining level so that it can meet the demand necessary to power the vehicle 100 at a later time using electric-only power from the electric machine 66.

At step 108, the vehicle 100 is operated normally in a CD mode until the battery SOC reaches a level equal to the reserved battery SOC calculated at step 104 (i.e. the battery SOC necessary for operating the vehicle 100 in EV mode over the travel range reservation). The vehicle 100 is next operated in CS mode (i.e., HEV mode) by turning on the engine 68 at step 110 in order to maintain the battery SOC at the charge sustaining level that is necessary to meet the travel range reservation.

At step 112, once the driver is ready to operate the vehicle 100 using the reserved battery SOC, the driver selects EV mode on the driver interface 60, such as by using the mode selector 70. The vehicle 100 is then controlled at step 114 using electric-only power over the travel range that was reserved during step 102. The exemplary energy management control strategy 101 may improve fuel economy of the vehicle 100.

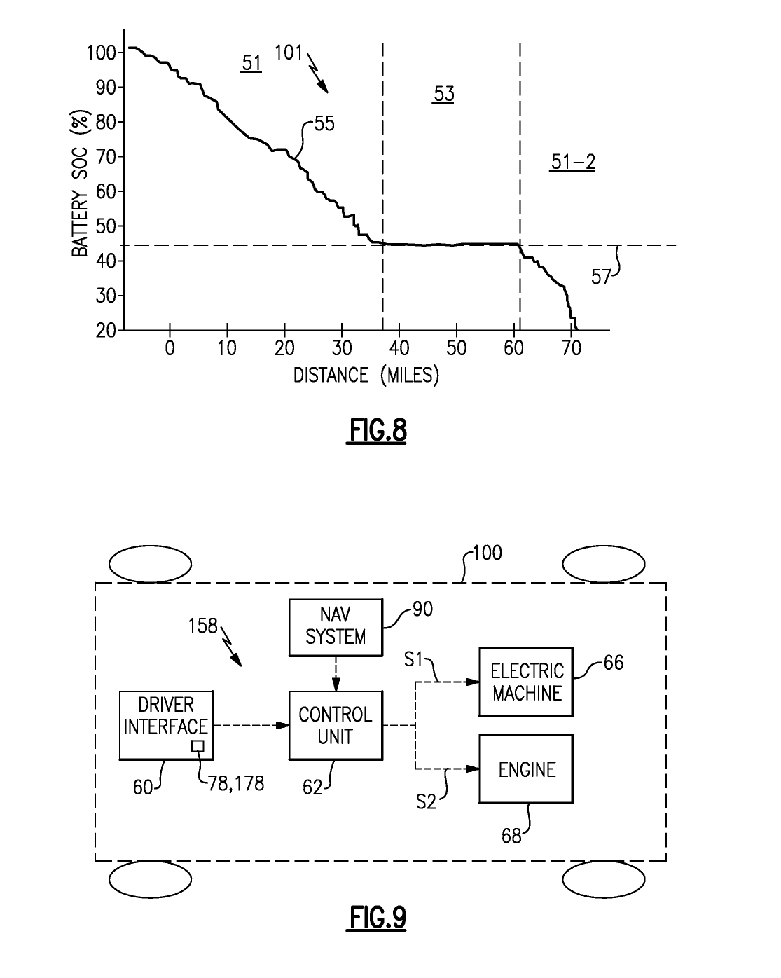

FIG. 8 graphically illustrates an exemplary implementation of the energy management control strategy 101 detailed with respect to FIG. 7. This embodiment assumes that the driver has selected a travel range reservation of 10 miles. The vehicle is operated in CD mode 51 until a charge sustaining level 57 has been reached. The charge sustaining level 57 is the battery SOC level 55 that is necessary to meet the travel range reservation demand. The vehicle is operated in CS mode 53 once the charge sustaining level 57 is reached. Finally, once the driver wishes to use the reserved battery SOC, the vehicle is operated in a second CD mode 51-2 over the 10 miles corresponding to the portion of a commute for which the driver previously made the travel range reservation. In this example, the 10 miles are at the end of the driver's commute. However, the travel range reservation can be made for any portion of the commute.

FIG. 9 illustrates another exemplary vehicle energy management system 158 that can be used to control a vehicle 100. In this disclosure, like reference numbers designate like elements where appropriate and reference numerals with the addition of 100 or multiples thereof designate modified elements that are understood to incorporate the same features and benefits of the corresponding original elements.

In this embodiment, the energy management system 158 is similar to the energy management system 58 of FIG. 3 but may additionally incorporate a navigation system 90. The navigation system 90 may utilize a global positioning system (GPS), for example, for displaying route and map information to the driver. The navigation system 90 could be incorporated into the driver interface 60 or could be a separate feature as is shown. The route and map information may be provided to the control unit 62 from the navigation system 90.

The navigation system 90 may be used to automatically operate the vehicle 100 in EV mode over a desired travel range reservation using battery SOC previously reserved by the driver. For example, a driver may enter a desired destination into the navigation system 90 and select a desired travel range reservation to be reserved for powering the vehicle in EV mode at a later point in the trip using a travel range reservation selector 78, 178 of the driver interface 60. Once the navigation system 90 indicates that the distance left to reach the destination is equal to the reserved travel range, the control unit 62 communicates a control signal 51 to turn on the electric machine 66 and a control signal S2 to turn off the engine 68 such that the vehicle 100 is operated in EV only mode automatically over the reserved travel range.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method, comprising:
controlling a vehicle in an Electric Vehicle (EV) mode that utilizes electric-only power to propel the vehicle, the controlling step based on a selection of a travel range reservation.

2. The method as recited in claim 1, wherein the travel range reservation is a distance in units of miles or kilometers.

3. The method as recited in claim 1, comprising:
manually selecting the EV mode once a desired portion of a commute has been reached by the vehicle; and
powering the vehicle in the EV mode in response to the manually selecting step.

4. The method as recited in claim 1, wherein the travel range reservation is part of an EV later mode strategy for controlling the vehicle.

5. The method as recited in claim 1, comprising calculating a corresponding battery state of charge that is necessary to meet the travel range reservation demand.

6. The method as recited in claim 1, comprising automatically powering the vehicle in EV mode based on navigation information.

7. The method as recited in claim 1, comprising:
operating the vehicle in a charge depleting mode until a charge sustaining level is reached; and
operating the vehicle in a charge sustaining mode after the charge sustaining level has been reached.

8. The method as recited in claim 7, comprising operating the vehicle in a second charge depleting mode once a desired portion of a commute is reached that corresponds to the travel range reservation.

9. The method as recited in claim 1, comprising communicating control signals to at least an electric machine and an engine to schedule operating modes of the vehicle.

10. The method as recited in claim 1, comprising selecting the travel range reservation on a driver interface of the vehicle.

11. A vehicle control method, comprising:
selecting a distance of electric-only travel to be reserved for powering a vehicle during a later portion of a commute; and
controlling the vehicle along the later portion of the commute based on the distance of electric-only travel that is reserved during the step of selecting.

12. The method as recited in claim 11, comprising calculating a corresponding battery state of charge that is necessary to power the vehicle over the distance of electric-only travel.

13. The method as recited in claim 11, wherein the step of controlling is performed in response to manually selecting an EV mode.

14. The method as recited in claim 11, wherein the step of controlling is automatically performed in response to navigation information.

15. The method as recited in claim 11, comprising controlling the vehicle along another portion of the commute in a HEV mode.

16. A vehicle energy management system, comprising:
a driver interface configured to select a travel range reservation; and
a control unit in communication with said driver interface and configured to control a vehicle using electric-only power based on said reserved travel range.

17. The system as recited in claim 16, wherein said vehicle is a plug-in hybrid electric vehicle (PHEV).

18. The system as recited in claim 16, wherein said driver interface includes a travel range reservation selector.

19. The system as recited in claim 16, wherein said driver interface includes a mode selector having an EV mode button, an Automatic mode button, and a HEV mode button.

20. The system as recited in claim 16, comprising a navigation system in communication with said control unit.
